(19) United States
(12) Patent Application Publication
(10) Pub. No.: US 2015/0242099 A1
(43) Pub. Date: Aug. 27, 2015

(54) AUTOMATICALLY GENERATING A MULTI-COLOR PALETTE AND PICKER

(71) Applicant: FIGMA, INC., Palo Alto, CA (US)

(72) Inventors: EVAN WALLACE, Palo Alto, CA (US); DYLAN FIELD, Palo Alto, CA (US)

(73) Assignee: FIGMA, INC., Palo Alto, CA (US)

(21) Appl. No.: 14/192,724

(22) Filed: Feb. 27, 2014

(51) Int. Cl. G06F 3/0484; G06T 11/00

(52) U.S. Cl. CPC G06F 3/04845; G06T 11/001

(57) ABSTRACT

A method and apparatus for automatically generating a multi-color palette and picker based on a set of colors is presented herein. Specifically, a method is described for generating a color palette with a plurality of anchors. Each anchor is assigned a color and a location in the color palette. The palette is colored with interpolated colors, based on each anchor's location. A user may select an interpolated color or an anchor color from the color palette and update one or more images and/or other objects with the selected color.

### FIELD OF THE INVENTION

The present invention relates to generating a color palette from which a color may be selected, and more specifically, to automatically generating a color palette and color picker based on a set of colors.

### BACKGROUND

Image editing applications allow users to select colors. The tools by which users may select specific colors are generally referred to herein as color pickers. Once a user using a color picker selects a color, the selected color may be used in conjunction with one of the image editing application's other tools, such as a paintbrush.

Typically, a color picker is a user interface (“UI”), or part of a UI, in an image editing application. Color pickers may take many forms. For example, a red-green-blue (“RGB”) color picker may have a color preview and three sliders: a red slider, a green slider, and a blue slider. In such an implementation, the color preview may be an area, such as a square, that is uniformly colored, and/or primarily colored, with a particular color (the “currently active” color). As a user adjusts each slider, the color picker may update the currently active color shown in the color preview. The user may adjust the sliders until the currently active color is the desired color. The user may then update an image based on the currently active color in the color preview.

An image editing application may have multiple color pickers. For example, an image editing application may have an RGB color picker and a Hue-Saturation-Value (“HSV”) color picker. An HSV color picker may also have a color preview and three sliders: a hue slider, a saturation slider, and a value slider. A user may adjust the sliders until the color preview displays a desired color. Also for example, an image editing application may include a swatch color picker, which displays several color previews each with a different color. A user may select the color preview with a particular color that the user would like to use.

An image editing application may also allow a user to select a color from an image. For example, a user may use a tool in an image editing application that selects a particular location of the image, causing the currently active color to be that color that is shown at the selected image location. Once selected, the image manipulation program may allow a user to modify the selected color using one or more color pickers, such as the RGB color picker or HSV color picker.

A user may want to select a color that is between several colors. For example, a shade of green, a shade of yellow, and a shade of blue may be prevalent in an image. A user may wish to select a color that is between the three colors and modify the image with the selected color. Using the color pickers discussed above, it may be difficult for a user to visualize and/or select a color that is between the three different colors.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. In the drawings:

FIG. 1 illustrates an interface for an image editing application with a color picker presented by a computer on a display, in an example embodiment.

FIG. 2, FIG. 3, and FIG. 4 illustrate a multi-anchor color picker, according to various example embodiments.

FIG. 5 illustrates the interface for an image editing application, in which an image is updated based on a color selected from a multi-anchor color picker, in an example embodiment.

FIG. 6 illustrates a process for generating a multi-anchor color picker interface on a computer, selecting a color, and updating an image, according to an example embodiment.

FIG. 7 is a block diagram that illustrates a computer system upon which an embodiment of the invention may be implemented.

While each of the drawing figures illustrates a particular embodiment for purposes of illustrating a clear example, other embodiments may omit, add to, reorder, and/or modify any of the elements shown in the drawing figures. For purposes of illustrating a clear example, a figure may be described with reference to one or more other figures, but using the particular arrangement(s) illustrated in other figures are not required in other embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

A “computer” is one or more physical computers, virtual computers, and/or computing devices. As an example, a computer may be one or more desktop computers, laptop computers, mobile devices, cloud-based computers, and cloud-based cluster of computers, virtual computer instances or virtual computer elements such as virtual processors, storage and memory, and/or any other special-purpose computing devices. Any reference to “a computer” herein may mean one or more computers, unless expressly stated otherwise.

A “process” means a process, thread, and/or instance of a program or application implemented as software and executed by a computer and/or virtual computer instance.

A process “performing” a step or method means the process performing the step or method, or a process causing another process to perform the step or method.

A “user” is a user that uses an image editing application on a computer to update images.

An “image editing application” is a set of instructions, which when executed by a computer allows a user to update electronically stored images. Additionally or alternatively, an image editing application is a set of instructions, which when executed by a computer allows a user to update figures projected on a display. For example, an image editing application may be a vector-based graphic editor. Also for example, an image editing application may be a three-dimensional rendering tool. Additionally or alternatively, an image editing application is a set of instructions, which when executed by a computer allows a user to select a color presented on a display. Additionally or alternatively, an image editing application is a set of instructions, which when executed by a computer allows a user to select a color by selecting a location on a display and/or color palette. An image editing application may be an application that is compiled for a particular hardware configuration, such as a mobile application, or interpreted instructions that are executable on a plurality of devices, such as a web application. An image editing application may comprise one or more processes performing one or more methods discussed herein.

A color that is “between” two or more colors is a color that is determined based on the two or more colors. For example, a color is between two colors if the color is computed by interpolating between the two colors in a color space. Also for example, a color is between two colors if the color is based on a weighted sum of the two colors.

A “color space” is a set of colors defined over a domain. For example, an RGB color space is a set of colors defined by a three-component domain: a red component, a green component, and a blue component. Also for example, a HSV color space is a set of colors defined by a three-component domain: a hue component, a saturation component, and a value component. Further, as an example, CMYK color space is a set of colors defined by a four-component domain: a cyan component, a magenta component, a yellow component, and a key (black) component. For convenience of expression a color in a color space may be denoted as a vector with angle brackets surrounding the color components, such as <A, B, C>, where A is the first component of the color, B is the second component of the color, and C is the third component of the color.

The “distance” or “closeness” between two colors may be computed in various ways according to one or more color spaces. In an embodiment, Euclidean distance may be used to determine the distance between two colors. For purposes of illustrating a clear example, assume a first RGB color is defined as <X, Y, Z>; and a second RGB color is defined as <A, B, C>. The distance, D, according to a Euclidean distance metric may be computed by the following equation:

D=\sqrt{V(X−A)²+(Y−B)²+(Z−C)²}.

A color is “similar” to another color if the colors are close.

The “sum” of two or more colors may be the component-wise sum of the two or more colors. For purposes of illustrating a clear example, assume a first RGB color is defined as <X, Y, Z>, a second RGB color is defined as <A, B, C>, and a third RGB color is defined as <I, J, K>. The third RGB color is the sum of the two other colors if <I, J, K> is equal to <X+A, Y+B, Z+C>.

The “weighted sum” of two or more colors is the component-wise weighted sum of two or more colors. For purposes of illustrating a clear example, assume a first RGB color is defined as <X, Y, Z>; a second RGB color is defined as <A, B, C>; a third RGB color is defined as <I, J, K>; a first weight, α, is a scalar value; and a second weight, β, is a scalar value. The third RGB color is the weighted sum of the two other colors if <I, J, K> is equal to <αX+βA, αY+βB, αZ+βC>.

A “location” may be a point on a canvas or grid. A location may correspond to a particular datum, such as a color, in a data structure and/or a particular pixel on a display. For example, a user may use a cursor to select a location on a screen. The location may correspond to a location in an image, color palette, and/or color picker. The location may correspond with a color defined in a color space and stored as a data structure, such as an array, comprising a plurality of colors which define an image, color palette, and/or color picker. Therefore, in an embodiment, if a location is selected a pixel on a display, a location on a color palette, and/or a color stored in a data structure may be selected.

A sample is a color, or is based on a color, at a particular location.

“Sampling a location” means determining the color at to a particular location on a display, in an image, and/or in a color palette. Additionally or alternatively, a sample may be based on one or more colors in the region of the particular location. For example, sampling a location may comprise determining the median color of a small region around the location.

### GENERAL OVERVIEW

Techniques are described herein for generating a color picker which includes a color palette with one or more anchors. Each anchor is associated with a color and a location on the color palette. A user may select the anchor colors and/or anchor locations on the color palette, or the anchor colors and/or anchor location may be selected automatically. Based on the locations and colors of the anchors on the color palette, the remainder of the color palette is colored with colors that are between the anchor colors. The user may select a location on the color palette to select the color at that location. The color thus selected may be used in conjunction with some other tool to edit an image.

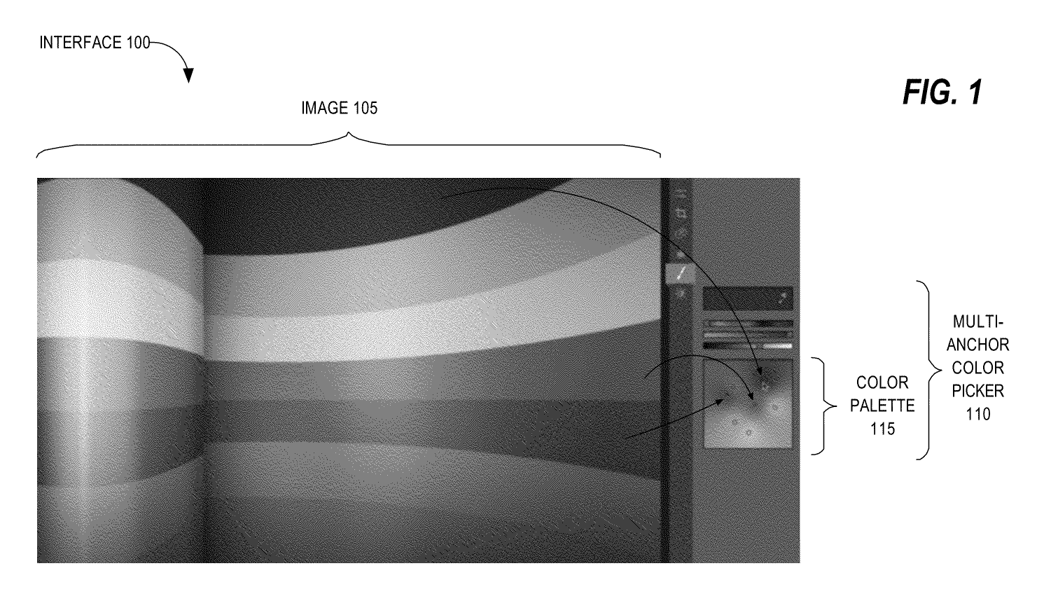

FIG. 1 illustrates an interface for an image editing application with a color picker presented by a computer on a display, in an example embodiment. In FIG. 1, interface 100 comprises image 105 and multi-anchor color picker 110. Multi-anchor color picker 110 is a multi-anchor color picker that has seven anchors. Each anchor, denoted by a colored circle in multi-anchor color picker 110, is assigned a color and a location on color palette 115. At the anchor locations, color palette 115 displays the color of each respective anchor. At all other locations, color palette 115 is colored with colors between each of the anchor colors. A user, using an image editing application with multi-anchor color picker 110, may select a color by selecting any location within the color palette 115. Selecting a location in color palette 115 automatically selects the color currently displayed at that location. Once a color is selected, the user may update an image, such as image 105, based on the selected color. The selected color may be an anchor color (if the user selects the location of an anchor) or a color that is in between one of the anchor colors.

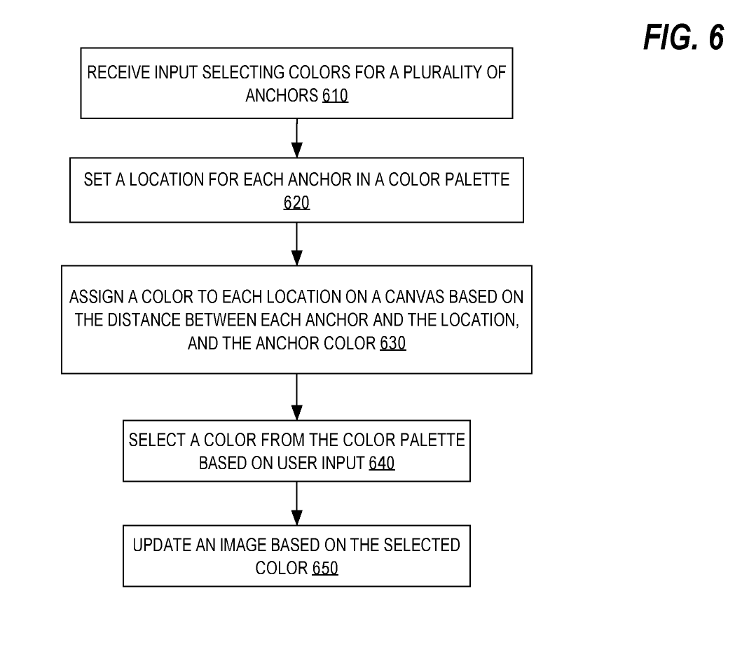

FIG. 6 illustrates a process for generating a multi-anchor color picker interface on a computer, selecting a color, and updating an image, according to an example embodiment. The steps discussed in FIG. 6 may be performed by a process, executed on a computer that presents the interface, or causes the interface to be presented on, a communicatively coupled display. The process may perform one or more of the steps in response to, or in concert with, various user inputs.

### Selecting Anchor Colors

In step 610, a process selects one or more colors for one or more anchors. The color of an anchor may be defined in RGB, HSV, CMYK, or any other color space.

### Selecting Anchor Colors Automatically

A process may automatically select one or more representative colors from an image to be one or more anchor colors. For example, the process may select one or more of the most common colors in an image to be anchor colors. However, an image may have several colors that are different, but similar Thus, merely selecting the most popular colors may cause the process to select colors that do not well represent the range of colors in an image. Alternatively, the process may segment an image and select representative colors from the segmented regions.

Statistical Region Merging (“SRM”) is a segmentation algorithm that a process may perform to automatically select representative colors from an image. SRM merges similar neighboring colors into regions based on color ranges, color difference thresholds, minimum region size, maximum region size, and/or number of representative colors desired.

The process may select one or more representative colors from the largest segmented regions after performing SRM and/or any other segmentation algorithm. Additionally or alternatively, the process may exclude one or more representative colors that are too close to another representative color or another anchor color.

The process may choose the representative color from a region by taking the most common color found in the region. Additionally or alternatively, the process may select a representative color from a region by computing an average region color. For example, the process may compute the average color for a region by computing the average red component, green component, and blue component of a plurality of colors in the region.

Lines and/or and animations may be used to show where the representative colors in an image are selected from. For example, the process may cause a line to be displayed from a location in an image with the representative color to multi-anchor color picker 110. Additionally, the process may cause the line may be drawn to the anchor in multi-anchor color picker 110 created and/or assigned the representative color. The arrows in FIG. 1 indicate where, within the image, an anchor color is selected from and where the corresponding anchor is positioned in color palette 115 of the multi-anchor color picker 110.

### Assigning an Anchor a Color Based on a User's Selection

A process may select one or more anchor colors in response to user input. For example, a user may select a location in an image using a mouse or other input device communicatively coupled to a computer. In response, a process may sample the image at the location and add an anchor, with the sampled color, to multi-anchor color picker 110.

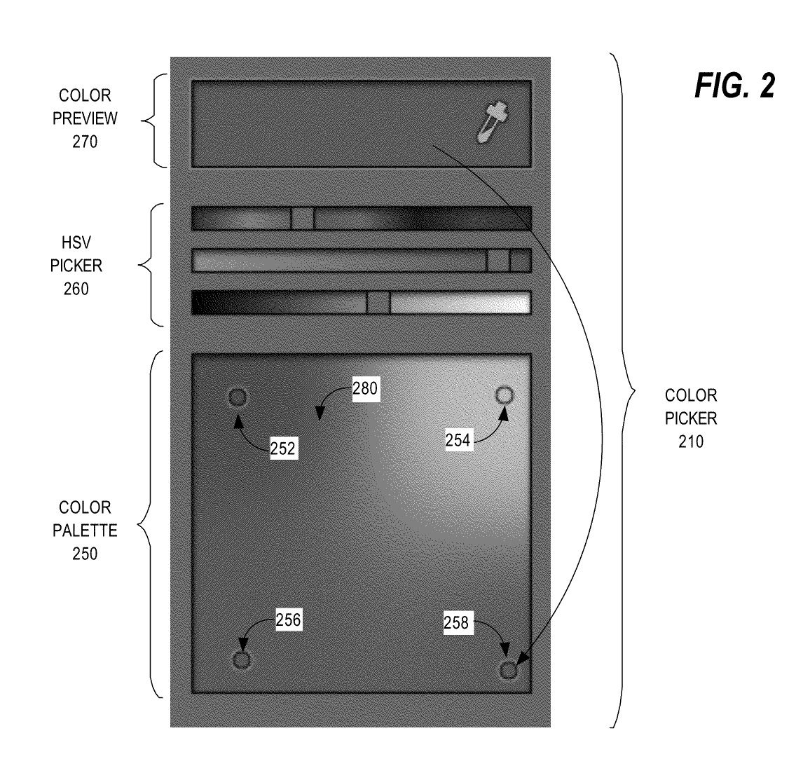

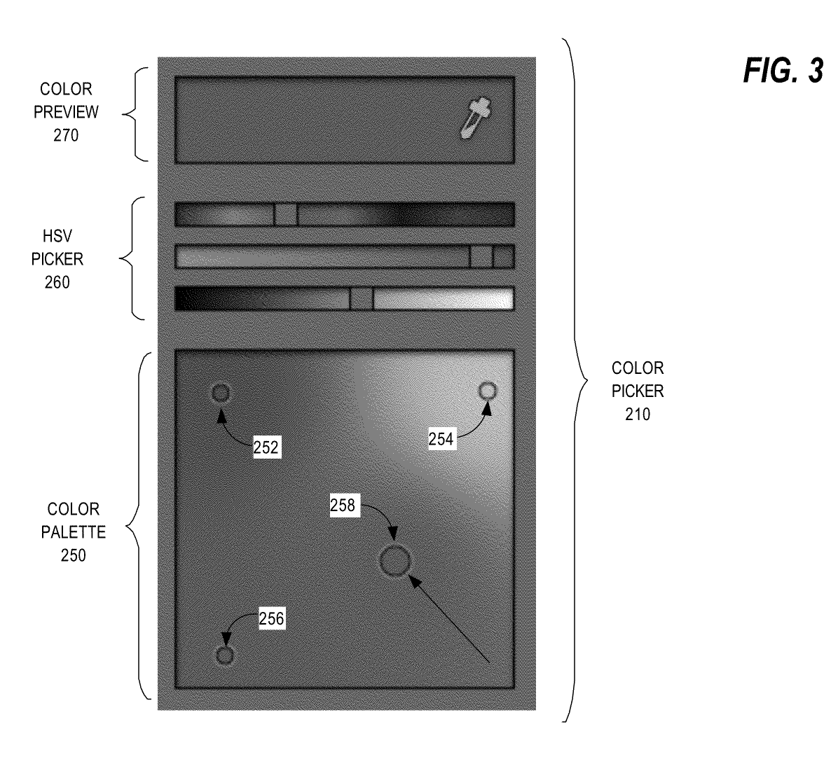

A process may select an anchor color from another color picker based on user input. FIG. 2, FIG. 3, and FIG. 4 illustrate a multi-anchor color picker, according to various example embodiments. In FIG. 2, FIG. 3, and FIG. 4, color picker 210 comprises color palette 250, HSV color picker 260, and color preview 270. In FIG. 2 and FIG. 3, color palette 250 includes four anchors: anchor 252, anchor 254, anchor 256, and anchor 258. In FIG. 4, color palette 250 includes three anchors: anchor 252, anchor 254, and anchor 256. A process may change the color displayed in color preview 270 in response to one or more user actions and/or inputs, such as adjusting the sliders in HSV picker 260, selecting a location in an image, selecting a location in color palette 250, and/or any other color picker. For convenience of expression, a process creating, updating, and/or deleting an anchor in color palette 250, means a process causing the anchor to be created, updated, and/or deleted from color palette 250 on a display.

In response to input indicating a user selected color preview 270, a process may generate an anchor, such as anchor 258 in color palette 250, and assign anchor 258 the color in color preview 270. Additionally or alternatively, in response to a user selecting color preview 270, a process may assign the color in color preview 270 to an already generated anchor, such as a previously selected anchor.

### Selecting a Location for Each Anchor

In step 620, the process sets a location for each anchor in a color palette. The location of an anchor may be selected automatically or by a user.

### Selecting Anchor Locations Using a Force Directed Graph

A process may perform one or more spacing algorithms to select locations for anchors in a color palette. A force directed graph is a spacing algorithm. A force directed graph comprises nodes and edges between the nodes. Each node and edge is assigned a force. The forces are applied to the nodes until equilibrium is reached. In an embodiment, the assigned forces may be based on the following spring equation, where F is the force, k is a spring constant and x is the displacement of the spring from its rest length:

F=−kx.

A process may automatically select locations for anchors in a color palette using a force directed graph. Using FIG. 2 as an example, a process randomly assigns a location and a force to each anchor in color palette 250: anchors 252, 254, 256, and 258. The process also defines edges (not illustrated) between anchors 252, 254, 256, and 258 and assigns a force to each edge. The process simulates the forces on the anchors to determine a “forced” location for each anchor in color palette 250. The process may stop the simulation after a particular amount of time, after particular number of iterations, until equilibrium is reached, and/or when any other criteria are satisfied. Additionally or alternatively, the process may apply one or more affine transformations to an anchor's forced location to select the anchor's location in color palette 250. Accordingly, color palette 250, in FIG. 2, illustrates anchors that are automatically assigned locations using a force directed graph, in an example embodiment.

### Dragging and Dropping Anchors on or onto a Color Palette

A user may drag and drop a color onto a color palette to generate an anchor with a particular color at a particular location. For example, a user may select color preview 270 by pressing a button, dragging a cursor over color palette 250, and releasing the button. In response, a process may generate anchor 258, display anchor 258 at the location where the cursor was when the button was released, and assign the color in color preview 270 to anchor 258.

A user may drag and drop a color from an image onto the color palette to generate an anchor with a particular color at a particular location. For example, a user may select a particular location in an image by pressing a button while a cursor is at the particular location. In response, the process samples the particular location in the image to select a particular color. The user may drag the cursor over color palette 250, and release the button. In response, the process may create an anchor, display the anchor at the location of the cursor when the button was released, and assign the particular color to the anchor.

### Rearranging Anchors on the Color Palette

Whether the anchors were initially placed automatically, or by a user, a user may subsequently change the location of an anchor by selecting an anchor and dragging the anchor to a new location. FIG. 3 illustrates an anchor that has been moved by a user in an example embodiment. In FIG. 3 anchor 258 is enlarged. A process may enlarge anchor 258 in response to receiving input indicating that a user selected anchor 258. In response to receiving input indicating that the user moved the cursor to a new location in color palette 250, the process translates anchor 258 to the new position in color palette 250. In response to receiving input indicating that the user has no longer selected anchor 258, the process may reduce the size of anchor 258 in color palette 250.

### Coloring the Color Palette

In step 630, the process assigns an interpolated color to each location on a palette based on each anchor's color and location. For example, the color assigned to location 280 in FIG. 2 is a weighted sum of the anchor colors located on color palette 250.

The weight applied to each anchor color may be different for each location on the color palette. For example, the weight applied to an anchor color to compute the color assigned to location 280, may be based on a fall-off function, such as the following function, where w is the weight being computed for an anchor, d is the distance between the anchor location and location 280, e is the exponential function, and k is a scalar:

$$w = \frac{1}{{e}^{k \cdot {d}^{2}} - 1}$$

Using the function above to determine the color of a target location on the color palette, the weight applied to each anchor color is based on both the anchor location and the target location. For example, to compute the color assigned to location 280, the weight applied to anchor 252's color is greater than the weight applied to anchor 254's color because anchor 252 is closer to location 280 than anchor 254 on color palette 250. In an embodiment, k is equal to 0.00025.

In an embodiment, the sum of the weights applied to the anchor colors to compute a color assigned a particular location on color palette 250 is equal to one. In an embodiment, the weights may be determined based on a decomposition or partitioning algorithm, such as Voronoi regions.

### Recoloring the Color Palette

In response to an anchor changing location or color, the color palette is recolored. For example, as anchor 258 is being dragged across color palette 250, color palette 250 is colored again using one or more of the methods discussed above, as illustrated between FIG. 2 and FIG. 3. In one embodiment, the color pallet 250 is repeatedly recolored in real time as the user drags an anchor, to accurately depict the result of placing the anchor at its current position as the anchor is being moved within the color palette.

In response to an anchor being added or removed from a color palette, the color palette is recolored. For example, if anchor 258 is deleted, then a process recolors color palette 250 again, as illustrated between FIG. 2 and FIG. 4.

### Updating an Image

In step 640, the process selects a color from the color palette based on user input. For example, in FIG. 4, in response to receiving input indicating that a user selected location 290 in color palette 250, the process samples the color, color 292, at location 290 in color palette 250. The process also causes color preview 270 to display color 292.

In step 650, in response to receiving one or more user inputs, the process updates an image based on the selected color. For example, in response to receiving input that a user is dragging a cursor over a selected image, the process may cause the image to be updated based on a selected color. The way in which the selected color is used to edit an image depends on the tool that is used in conjunction with the multi-anchor color picker 110, and the techniques described herein are not limited to any particular tool for making use of the selected color.

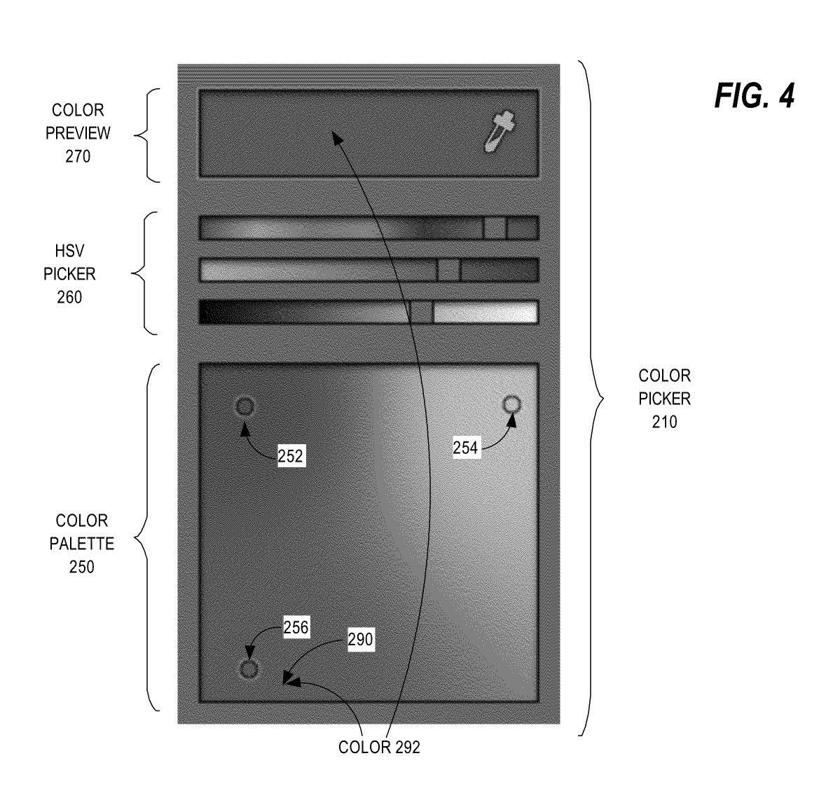

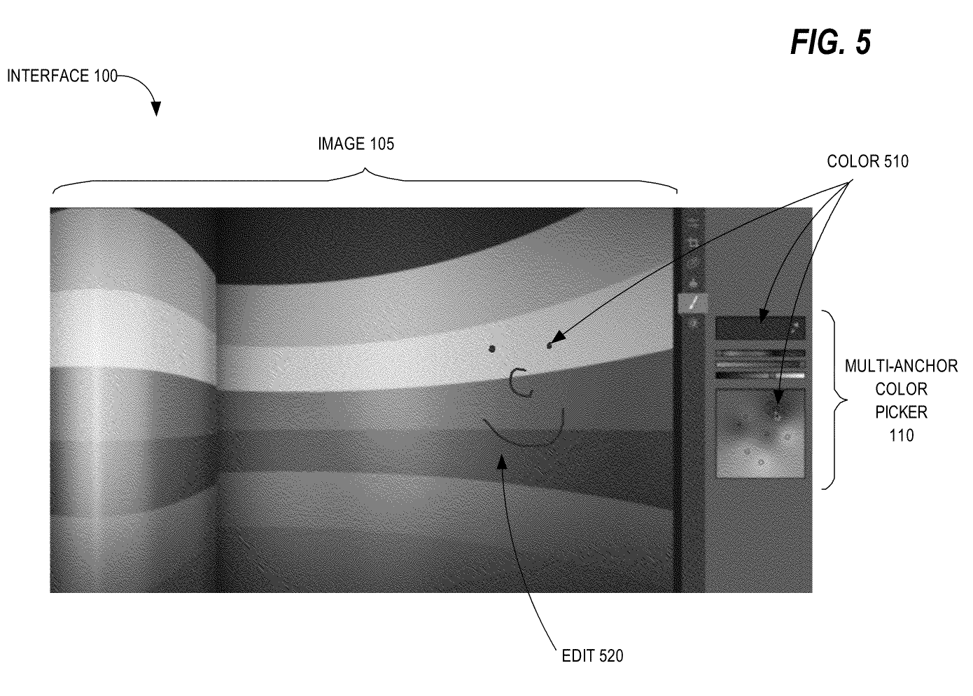

FIG. 5 illustrates the interface for an image editing application, in which an image is updated based on a color selected from a multi-anchor color picker, in an example embodiment. FIG. 5 includes image 105 and multi-anchor color picker 110. In FIG. 5 in response to receiving input from a user, color 510 is selected from the color palette and displayed in the color preview in multi-anchor color picker 110. In response to receiving input that the user is moving a cursor over an image, the process may update image 105 with edit 520.

Edit 520 is an example of a free-hand line drawing using a color selected from multi-anchor color picker 110; one or more other edits of image 105 may be made using color 510. For example, a fill tool, mask tool, blending tool, and/or any other tool that uses a color as an input or factor may use the selected color, color 510, to update image 105.

Image 105 and multi-anchor color picker 110 are illustrated as if side-by-side. However, a color selected from multi-anchor color picker 110 may be used to update one or more images that are not side-by-side with multi-anchor color picker 110. For example, a process may use a color selected from multi-anchor color picker 110 to update one or more images that are not currently displayed. Also for example, as part of a batch rendering process, the batch rendering process may use the selected color to update one or more images stored in memory or persistent storage. The one or more images need not be displayed at the time the process updates the one or more images. Furthermore, a process may use the selected color to update one or more other media or multimedia content, such as a movie.

Additionally or alternatively, other updates or changes may be made to other images or data sets based on the selected color. For example, in a three-dimensional rendering application, a user may select an object, such as a sphere. In response, the three-dimensional rendering application may cause the sphere to be colored based on the selected color in step 640. Additionally or alternatively, a light source, vector, or other object may be selected. In response, the three-dimensional rendering application may simulate light and/or modify an object based on the color selected in step 640. Additionally or alternatively, another application and/or type of application may use the color selected in step 640. For example, a vector graphics tool may update one or more vector-based graphics based on the color selected in step 640.

Additionally or alternatively, other color pickers may be updated based on the selected color in step 640. For example, in response to a user selected a color in step 640, a color picking application may pick one or more other colors based on a color matching algorithm, or complementary color algorithm.

Additionally or alternatively, a color may be selected in step 640 by a user on a mobile device. In response, an application, running on a desktop computer, may receive data describing the selected color. The application may cause one or more objects to be updated based on the selected color.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

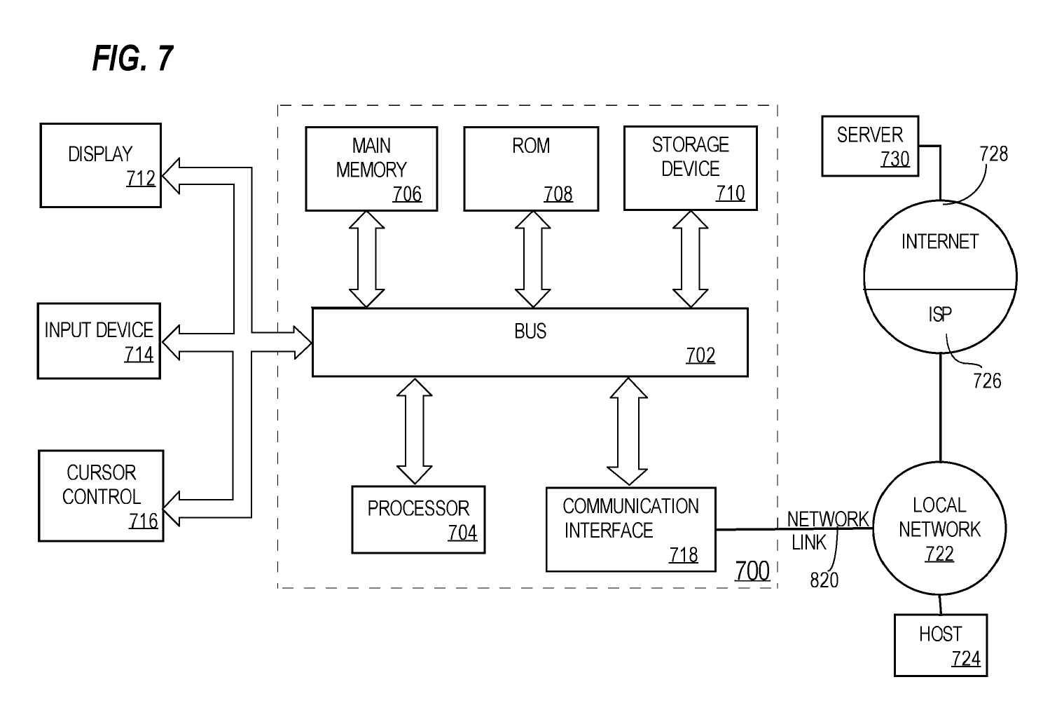

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
for each anchor location of a plurality of anchor locations, assigning an anchor color to the anchor location;
wherein at least two of the plurality of anchor locations are assigned anchor colors having different hues;
wherein the plurality of anchor locations includes at least three anchor locations;
wherein the plurality of anchor locations reside within a region of a display generated by a computing device, wherein the region encompasses a plurality of pixels;
causing each pixel in the region to be colored with a color that is based, at least in part, on:
the anchor color assigned to each anchor location; and
a distance between the location pixel and each anchor location;
wherein the method is performed by one or more processors.

2. The method of claim 1, wherein:
the display is generated on a monitor that has pixels;
causing each pixel in the region to be colored comprises causing each pixel in the region to be colored with the color that is based, at least in part, on:
the anchor color assigned to each anchor location; and
the distance between the location pixel and each anchor location.

3. The method of claim 1 further comprising:
receiving an input from a user;
determining a selected pixel within the region based on the input;
establishing the color of the selected pixel as a selected color to be used by an image editing tool;
in response to use of the image editing tool, updating an image by applying the selected color to at least a portion of the image.

4. The method of claim 1, wherein the color of each pixel in the region is based, at least in part, on the distance between the pixel and each anchor location and a fall-off function.

5. The method of claim 1, wherein causing each pixel in the region to be colored comprises:
determining a weight for each anchor color based, at least in part, on a squared distance between the pixel and the anchor location of the anchor color;
summing a contribution of each anchor color based, at least in part, on the weight determined for the anchor color.

6. The method of claim 1 further comprising:
receiving a first input from a user selecting a first anchor color;
receiving a second input from the user indicating a new anchor location for the first anchor color;
assigning the new anchor location to the first anchor color in response to the second input;
causing each pixel in the region to be re-colored with a color that is based, at least in part, on a new distance between the pixel and the new anchor location.

7. The method of claim 1 further comprising:
receiving a first input from a user selecting a new color;
receiving a second input from the user indicating a new anchor location for a new anchor color;
adding the new anchor color to the region at the new anchor location;
causing each pixel in the region to be re-colored with a color that is based, at least in part, on:
the new anchor color; and
a new distance between the pixel and the new anchor location.

8. The method of claim 1 further comprising, for each anchor location of the plurality of anchor locations, assigning the anchor color from an image, wherein each anchor color is defined in the image.

9. The method of claim 8 further comprising:
segmenting the image based on statistical region merging into a set of segmented regions;
determining a representative color for each segmented region in the set of segmented regions to produce a set of representative colors;
for each anchor location of the plurality of anchor locations, assigning the anchor color from the set of representative colors.

10. The method of claim 1 further comprising:
assigning each anchor location of the plurality of anchor locations and the anchor color assigned to the anchor location to a corresponding vertex in a force directed graph;
simulating forces that attract and repel each vertex in the force directed graph;
assigning the anchor location of each anchor color based on the corresponding vertex in the force directed graph.

11. The method of claim 1 further comprising:
receiving a first input from a user selecting a first anchor color at a first anchor location;
receiving a second input from the user indicating that the first anchor color at the first anchor location should be removed from the region;
removing the first anchor color from the first anchor location in the region;
causing each pixel in the region to be re-colored based on one less anchor color and one less anchor location.

12. One or more non-transitory computer-readable media storing instructions which, when executed by one or more processors, cause performance of a method comprising:
for each anchor location of a plurality of anchor locations, assigning an anchor color to the anchor location;
wherein at least two of the plurality of anchor locations are assigned anchor colors having different hues;
wherein the plurality of anchor locations includes at least three anchor locations;
wherein the plurality of anchor locations reside within a region of a display generated by a computing device, wherein the region encompasses a plurality of pixels;
causing each pixel in the region to be colored with a color that is based, at least in part, on:
the anchor color assigned to each anchor location; and
a distance between the pixel and each anchor location;
wherein the method is performed by one or more processors.

13. The one or more non-transitory computer-readable media of claim 12, wherein:
the display is generated on a monitor that has pixels;
causing each pixel in the region to be colored comprises causing each pixel in the region to be colored with the color that is based, at least in part, on:
the anchor color assigned to each anchor location; and
the distance between the pixel and each anchor location.

14. The one or more non-transitory computer-readable media of claim 12, the method further comprising:
receiving an input from a user;
determining a selected pixel within the region based on the input;
establishing the color of the selected pixel as a selected color to be used by an image editing tool;
in response to use of the image editing tool, updating an image by applying the selected color to at least a portion of the image.

15. The one or more non-transitory computer-readable media of claim 12, wherein the color of each pixel in the region is based, at least in part, on the distance between the pixel and each anchor location and a fall-off function.

16. The one or more non-transitory computer-readable media of claim 12, wherein causing each pixel in the region to be colored comprises:
determining a weight for each anchor color based, at least in part on a squared distance between the pixel and the anchor location of the anchor color;
summing a contribution of each anchor color based, at least in part, by on the weight determined for the anchor color.

17. The one or more non-transitory computer-readable media of claim 12, the method further comprising:
receiving a first input from a user selecting a first anchor color;
receiving a second input from the user indicating a new anchor location for the first anchor color;
assigning the new anchor location to the first anchor color in response to the second input;
causing each pixel in the region to be re-colored with a color that is based, at least in part, on a new distance between the pixel and the new anchor location.

18. The one or more non-transitory computer-readable media of claim 12, the method further comprising:
receiving a first input from a user selecting a new color;
receiving a second input from the user indicating a new anchor location for a new anchor color;
adding the new anchor color to the region at the new anchor location;
causing each pixel in the region to be re-colored with a color that is based, at least in part, on:
the new anchor color; and
a new distance between the pixel and the new anchor location.

19. The one or more non-transitory computer-readable media of claim 12, the method further comprising, for each anchor location of the plurality of anchor locations, assigning the anchor color from an image, wherein each anchor color is defined in the image.

20. The one or more non-transitory computer-readable media of claim 19, the method further comprising:
segmenting the image based on statistical region merging into a set of segmented regions;
determining a representative color for each segmented region in the set of segmented regions to produce a set of representative colors;
for each anchor location of the plurality of anchor locations, assigning the anchor color from the set of representative colors.

21. The one or more non-transitory computer-readable media of claim 12, the method further comprising:
assigning each anchor location of the plurality of anchor locations and the anchor color assigned to the anchor location to a corresponding vertex in a force directed graph;
simulating forces that attract and repel each vertex in the force directed graph;
assigning the anchor location of each anchor color based on the corresponding vertex in the force directed graph.

22. The one or more non-transitory computer-readable media of claim 12, the method further comprising:
receiving a first input from a user selecting a first anchor color at a first anchor location;
receiving a second input from the user indicating that the first anchor color at the first anchor location should be removed from the region;
removing the first anchor color from the first anchor location in the region;
causing each pixel in the region to be re-colored based on one less anchor color and one less anchor location.
